(19) United States
(12) Patent Application Publication
(10) Pub. No.: US 2015/0081287 A1
(43) Pub. Date: Mar. 19, 2015

(54) ADAPTIVE NOISE REDUCTION FOR HIGH NOISE ENVIRONMENTS

(71) Applicant: Advanced Simulation Technology, Inc. ("ASTi"), Herndon, VA (US)

(72) Inventors: Kevin ELFENBEIN, Arlington, VA (US); Neil Kenneth Waterman, Leesburg, VA (US); James Kenneth Norton, Reston, VA (US)

(21) Appl. No.: 14/482,684

(22) Filed: Sep. 10, 2014

Related U.S. Application Data
(60) Provisional application No. 61/877,476, filed on Sep. 13, 2013.

(51) Int. Cl. G10L 19/028

(52) U.S. Cl. CPC G10L 19/028
USPC 704/226

(57) ABSTRACT

Systems, methods, and devices for providing noise reduction to an audio signal, such as a speech signal, to improve the accuracy of a speech recognition system. The various embodiments may be particularly useful for training and simulation systems.

### RELATED APPLICATION

This application claims the benefit of priority to U.S. Provisional Application No. 61/877,476, filed on Sep. 13, 2013, the entire contents of which are incorporated herein by reference.

### FIELD OF THE INVENTION

The present invention relates generally to systems and methods for providing noise reduction to an audio signal, such as a speech signal. More particularly, the present invention includes methods and systems for applying noise reduction to a speech signal in order to improve the accuracy of a speech recognition system.

### BACKGROUND

Automatic speech recognition (ASR) systems enable machines to identify and convert spoken language into a machine-readable format, such as text. Many simulation systems (e.g., training systems) that include a communication component already or will in the foreseeable future incorporate ASR into the systems. In order for speech recognition systems to be effectively incorporated into simulation systems, the speech recognition systems need to be extremely accurate. For example, a speech recognition engine typically needs to achieve a word error rate (WER) in the 2-5% range or lower to be useful for simulation systems.

In many simulation systems, the speech recognition must take place in an environment where there is significant background noise. Furthermore, the background noise may be dynamic and change unpredictably during the simulation. Under such conditions, the word error rate of an ASR system increases dramatically, rendering such systems unusable as a practical matter. In addition, a training simulation system may require the trainees to use similar or identical equipment as is used in the actual environment the system is intended to simulate. For example, a military or aviation simulation system may utilize standard-issue military or aviation communication systems (e.g., headsets). Conventional techniques for reducing noise, such as using specialized microphones or other hardware solutions, may not be useable in a simulation system. To date, there are many situations where the problem of background noise in speech recognition systems has not proven amenable to a practical solution.

### SUMMARY

The systems, methods, and devices of the various embodiments provide noise reduction to an audio signal. In an embodiment, a method may include receiving frames of data corresponding to an audio signal from a microphone, determining whether a current frame is a speech frame or a non-speech frame based on at least one threshold, updating a noise profile with at least one characteristic of the current frame when the current frame is determined to be a non-speech frame, and performing noise reduction on at least each speech frame using the noise profile.

In various embodiments, the at least one threshold may be based on a characteristic of one or more preceding frames. The characteristic may be the spectral energy and/or entropy of the one or more preceding frames, and/or whether the one or more preceding frames were determined to be a speech frame or a non-speech frame. The method may further include updating the at least one threshold based on a characteristic of the current frame, and determining whether a successive frame is a speech frame or a non-speech frame based on the updated at least one threshold.

In various embodiments, the noise profile may not be updated when the current frame is determined to be a speech frame. The noise profile may comprise an estimate of the spectral content of background noise received at the microphone, and may be generated based on the spectral content of non-speech frames. The noise reduction may include performing spectral subtraction on the current frame using the noise profile, and/or applying a weighting function to the current frame. The weighting function may be based on at least one of a formant analysis, a harmonic analysis, and auditory perception properties.

In various embodiments, following noise reduction the audio data corresponding to the now noise reduced audio signal received by the microphone may be provided as in input to an automatic speech recognition (ASR) system.

Various embodiments include systems, including simulation systems, configured to perform operations of the embodiment methods disclosed herein. Various embodiments also include systems including means for performing functions of the embodiment methods disclosed herein. Various embodiments also include non-transitory processor-readable storage media having stored thereon processor-executable instructions configured to cause a processor to perform operations of the embodiment methods disclosed herein.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a system for providing noise reduction to an audio signal according to an embodiment.

FIG. 2 is a diagram illustrating the process flow of a noise reduction system according to an embodiment.

FIG. 3 is a flow diagram of a voice activity detection stage according to an embodiment.

FIG. 4 is a flow diagram of an adaptive enhanced spectral subtraction stage according to an embodiment.

FIG. 5 is a flow diagram illustrating a formant analysis process according to an embodiment.

FIG. 6 is a flow diagram illustrating a harmonic analysis process according to an embodiment.

FIG. 7 is a process flow diagram illustrating a method of reducing noise in an audio signal according to an embodiment.

FIG. 8 is a component block diagram of a computing device suitable for use in the various embodiments.

FIG. 9 is a component block diagram of a server suitable for use in the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used to refer to any one or all of desktop computers, server computers, workstation computers, simulation and training computers, vehicle or aircraft computers, personal data assistants (PDA's), laptop computers, tablet computers, smart phones, smart books, palm-top computers, gaming controllers, and similar electronic devices which include a programmable processor and memory and circuitry for processing an electronic representation of an input audio signal received at a microphone.

The various embodiments are described herein using the term “server.” The term “server” is used to refer to any computing device capable of functioning as a server, such as a master exchange server, web server, mail server, document server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as laptop computer, thereby enabling it to function as a server (e.g., an enterprise e-mail server) only to the extent necessary to provide the functionality described herein.

As used herein the term “voice activity detector,” or “VAD,” refers to a dedicated piece of hardware, such as a chip, computing device, etc., and/or a software application, such as a standalone application or module within an application, that includes functionality for determining whether speech (or similar audio component with an isolatable frequency profile) is present on an input signal at a given point in time.

As used herein the terms “noise reduction stage” and “noise reduction module” are used interchangeably to refer to a dedicated piece of hardware, such as a chip, computing device, etc., and/or a software application, such as a standalone application or module within an application, that includes functionality for removing a portion of a signal, such as using spectral subtraction, based on a representation of the background noise in an environment.

As used herein, the terms “automatic speech recognition (ASR) system” and “speech recognizer” are used interchangeably to refer to a dedicated piece of hardware, such as a chip, computing device, etc., and/or a software application, such as a standalone application or module within an application, that includes a speech recognition engine for converting spoken words into a machine-readable format, such as text.

The systems, methods, and devices of the various embodiments provide a robust technique for reducing the noise present in a speech signal in a high-energy, non-stationary noise environment. As used herein a “non-stationary” noise environment means that the background noise is dynamic, i.e., in a statistical sense, the mean and variance of the noise changes over time. In the case of a military or commercial simulator, for example, this change may be caused by sources of noise that move relative to the microphone. However, movement of the noise source relative to the microphone is only an example of one “non-stationary” noise environment and “non-stationary” is used herein to refer more broadly to any noise on the actual audio samples captured by the microphone being dynamic and is not limited by the cause of the changes in the noise. In embodiments, the systems, methods and devices may be used as a pre-processing stage of an automatic speech recognition (ASR) system. Systems and methods of the various embodiments may include continuously analyzing the background noise in an environment and constructing an estimate of the noise profile by monitoring the input signal from a single microphone. Using the knowledge of this profile, a voice activity detector (VAD) may determine when a user is speaking into the microphone and choose the relevant portions of the signal to accurately update the noise profile. In an embodiment, the systems and methods may separate the speech and background noise components of the signal during speech in order to monitor the noise for changes. The systems and methods may reduce the amount of noise in the signal by subtracting the current noise profile from the input signal. In certain embodiments, an iterative process may be employed that feeds the output signal back into the input for a second stage of analysis and noise reduction. The output of the various embodiment systems may be fed into an automatic speech recognition (ASR) system.

In various embodiments, a noise reduction method and system may include at least two stages, including a voice activity detector (VAD) stage and an adaptive enhanced spectral subtraction stage. An input signal may be processed with minimal delay, meaning that the signal may be analyzed and modified as digital samples are collected from the microphone (as opposed to being stored for later analysis). Small delays in the audio signal (e.g., less than 10 seconds, such as 1-5 seconds, and typically less than about 1 second, such as 1-500 milliseconds, including 20-300 milliseconds) may be incurred during processing of the input signal. However, such delays may be acceptable for the purpose of improving the recognition rate of an ASR. Digital audio samples may be collected from a single microphone (such as Pulse Code Modulated (PCM) digital samples of the analog electrical signal output by the single microphone thereby forming a digital electrical signal representing the audio signal received by the single microphone) constituting audio data and the audio data may be buffered into frames each representing a short (e.g., less than 1 second, such as less than 100 milliseconds, including 5-50 milliseconds) block of time. In this manner, a frame may be comprised of audio data formed from a series of collected samples and may effectively include the audio data of a portion of the digital electrical signal representing the audio signal received at the single microphone. Each frame may have a finite length, and the system may analyze each frame individually. Each frame of audio data may be processed through both the VAD stage and the adaptive enhanced spectral subtraction stage.

In an embodiment, when a complete frame of audio data is collected, the system may convert the frame to the frequency domain for analysis, and then extract characteristics or features of the current frame that are different for frames of speech and frames of non-speech. These extracted characteristics may include energy and/or spectral entropy of the frame which may be different depending on whether the user is speaking or not speaking. In the various embodiments, frequency thresholds and weighting based on knowledge of perception and speech may be applied so that the most relevant frequency data is proportionally utilized for characteristic extraction. In an embodiment, the VAD may include two thresholds proportional to a measured background characteristic, a threshold T1 for determining the transition from non-speech to speech and a threshold T2 for determining the transition from speech to non-speech. These thresholds may be continually updated based on the current estimates of spectral energy and entropy of the background noise. In response to determining that the system is currently in a non-speech state (i.e., the previous frame was determined to be a frame of non-speech) and the current energy and entropy levels are greater than their respective T1 values, the current frame may be classified as speech. In response to determining that the system is currently in a speech state and the current energy and entropy levels are lower than their respective threshold T2 values, the current frame may be classified as non-speech. Other factors such as the number of previous consecutive frames of speech or consecutive frames of non-speech may also be utilized for smooth and robust classification of each frame as a speech frame or a non-speech frame.

Once each frame is classified as being either speech or non-speech, in an embodiment, the frame may be passed to the adaptive enhanced spectral subtraction stage. In an embodiment, the adaptive enhanced spectral subtraction stage may also use the frequency domain of the audio data. In an embodiment, a current noise profile may be updated by recursively applying a weighted average to the spectrum of those frames classified as non-speech. In an embodiment, the current noise profile may not be updated based on frames classified as speech frames. This may help to prevent the adaptive enhanced spectral subtraction stage from subtracting energy in spectral bands associated with speech (i.e., cancelling the energy of the speech signal of interest). Spectral subtraction may be performed on at least each of the speech frames, and preferably on all the frames regardless of speech or non-speech classification.

In an embodiment, the spectral subtraction may include the following steps. The frequency spectrum of the current frame may be divided into logarithmically spaced bands based on the resolution of auditory perception in humans. The segmental signal-to-noise ratio (SNR) of each band in the current frame's spectrum may be calculated and used to determine an appropriate subtraction factor for that band. For each band, the noise profile spectrum multiplied by the subtraction factor may be subtracted from the current frame's spectrum (referred to as over-subtraction). Each frequency bin may be compared to a minimum magnitude threshold and set to that threshold if the frequency is lower than the threshold. A frequency domain weighting function may be calculated based on formant and harmonic analysis of the resulting spectrum, auditory perception characteristics, and/or noise profile characteristics. This weighting function may be applied to the current frame's spectrum after spectral subtraction, and may further reduce noise while enhancing the speech in the audio data of the frame (corresponding to the portion of the digital electrical signal representing the audio signal received at the microphone included in the frame) to promote accurate recognition by an ASR. The processed frame audio data with reduced noise may then be converted back into the time domain and the noise reduced audio data (corresponding to the digital electrical signal representing a noise reduced version of the audio signal received by the microphone) included in the processed frame may be stored and/or provided as an input to an ASR system. In this manner, the ASR may receive noise-reduced audio data corresponding to a noise-reduced version of the audio signal received at the single microphone.

In various embodiments, the system may be tuned for robust and effective performance in simulation environments, including military and aviation (e.g., air traffic) simulation environments. Embodiments of the invention may take advantage of latency allowable in speech recognition applications to perform intensive processing for lower word error rates in noisy environments. Embodiments may use a single microphone (e.g., a standard-issue communication headset) to provide the audio input and no extra hardware may be required for the operator (e.g., no extra microphones).

The various embodiments may enable an increased SNR of an input signal in a noisy environment, including in a noisy simulation environment. The various embodiments may preserve and/or enhance the intelligibility of a speech signal in a noisy environment. The various embodiments may also be used to increase the accuracy of an ASR system in a noisy environment by adding the present noise reduction technique as a pre-processing stage.

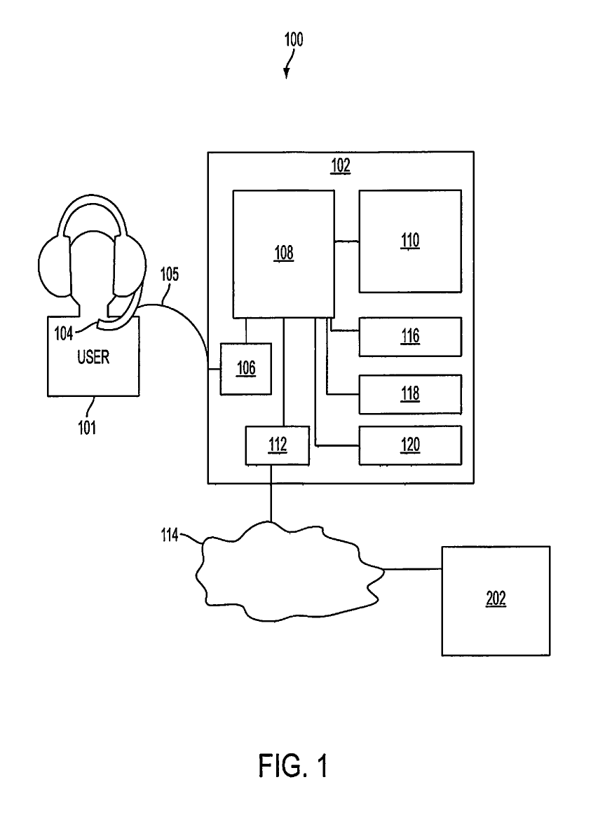

FIG. 1 schematically illustrates a system 100 for use with the present embodiments, which may be, for example, a simulation system. The system 100 includes a microphone 104 for capturing audio and a computing device 102 operatively coupled to the microphone 104. Any type of microphone may be used in the various embodiments, one example of which is the microphone 104 that may be part of a communication headset worn by a user 101. The microphone 104 detects/receives audio signals, including speech from the user 101 as well as background noise, which may be for example, ambient noise, background chatter, voices of people other than the user, etc. The microphone 104 converts received audio signals into an electrical representation of the audio signals, i.e., analog electrical signals. Such analog electrical signals may be provided as an input directly to the computing device 102 via a suitable link 105 (e.g., a wire or wireless link).

The computing device 102 may be any type of device, such as a standalone device dedicated to processing audio signals received from a microphone 104, or a device performing various other functions in addition to processing audio signals, such as a laptop computer, server, simulator workstation, etc. configured to perform audio signal processing as discussed herein. The computing device 102 may include a processor 108 coupled to internal memory 110. The processor 108 may be any programmable microprocessor, microcomputer or multiple processor chip or chips that can be configured by software instructions (applications) to perform a variety of functions, including the functions of the various embodiments described herein. Typically, software applications may be stored in the internal memory 110 before they are accessed and loaded into the processor 108. In some embodiments, a voice activity detector (VAD) and/or noise reduction module (e.g., adaptive enhanced spectral subtraction module) as described further below may be embodied as processor-executable instructions (i.e., program code) stored in memory 110 and executed by processor 108.

The computing device 102 may also include an analog-to-digital converter module 106 to convert the analog electrical signals received from the microphone 104 (that is an electrical representation of the audio signals received from the microphone 104) into audio data corresponding to digital electrical signals representing the audio signals received at the microphone 104 before further processing by the processor 108. Although the analog-to-digital converter module 106 is shown as part of the computing device 102, it will be understood that module 106 can be a stand-alone unit or part of the headset/microphone 104. The computing device 102 may also include a communication module 112 that enables the unit 102 to transmit and receive data to and from one or more external entities, such as an external device 202. The communication between the computing device 102 and an external device 202 may be via a network 114, which may be a local area network (LAN) or a wide area network, such as the Internet. In some embodiments, the computing device 102 may transmit processed (i.e., noise reduced) audio data corresponding to digital electrical signals representing reduced noise versions of the audio signals received by the microphone 104 to an external device 202 including an ASR engine for performing automated speech recognition on the noise reduced audio data. In other embodiments, the computing device 102 may include an ASR engine that performs the speech recognition.

Other components of the computing device 102 may include an input/output device 116, such as a CD-ROM drive, USB port, etc., a display 118, and a user input device 120, such as a keyboard, mouse, touch pad, etc.

Although for clarity, the various components of the computing device 102 are shown as part of a single device, it will be understood that the computing device 102 may comprise a plurality of separate devices that may be in communication and configured to exchange data. For example, one or more first device(s) may be configured to perform a voice activity detection (VAD) stage, one or more second device(s) may be configured to perform an adaptive enhanced spectral subtraction stage, and one or more third device(s) may be configured perform automated speech recognition stage.

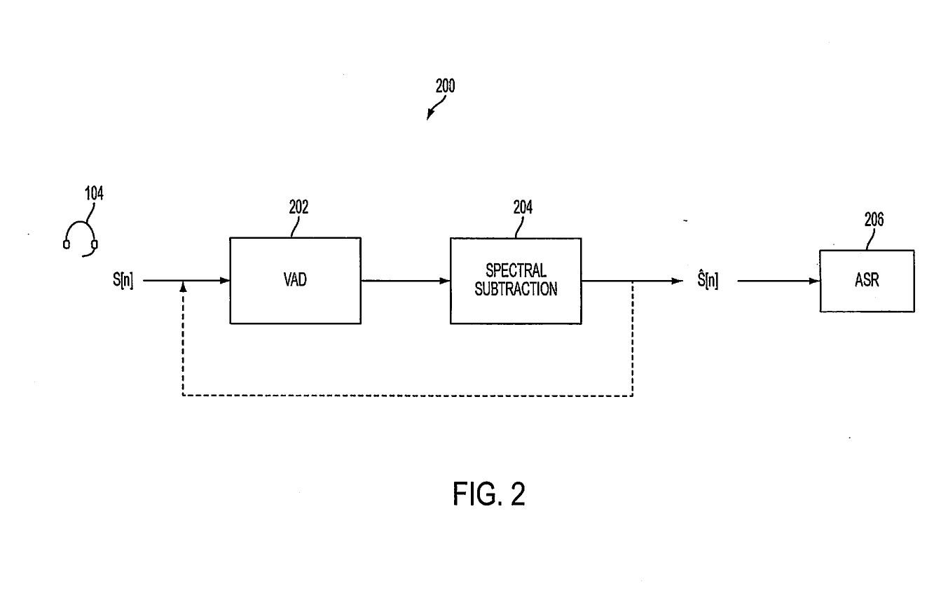

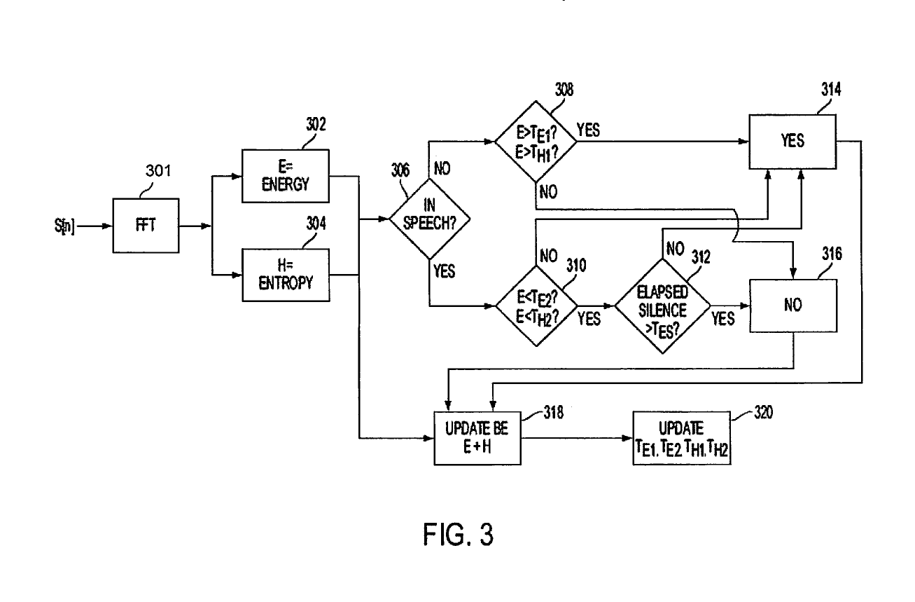

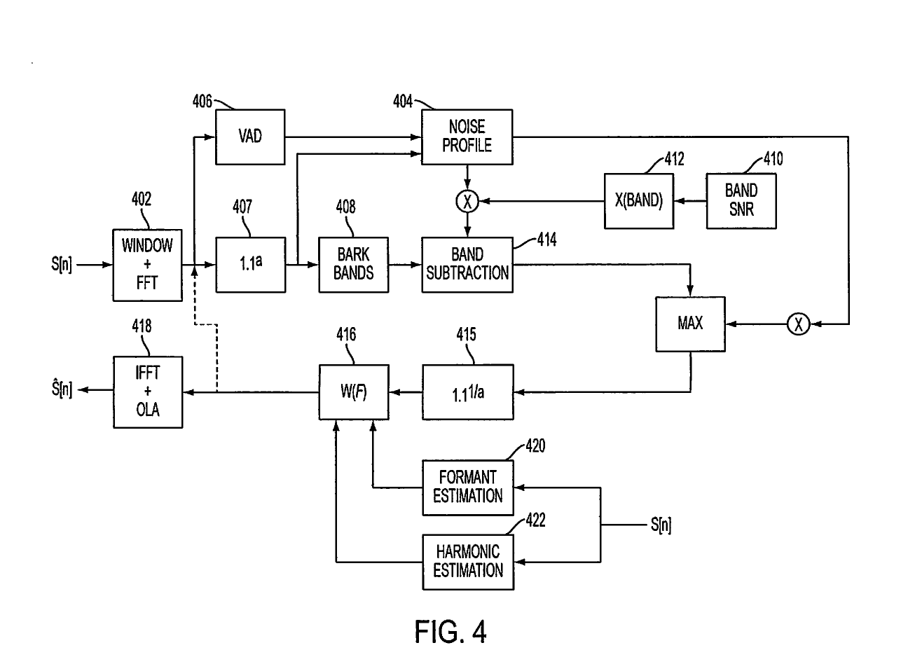

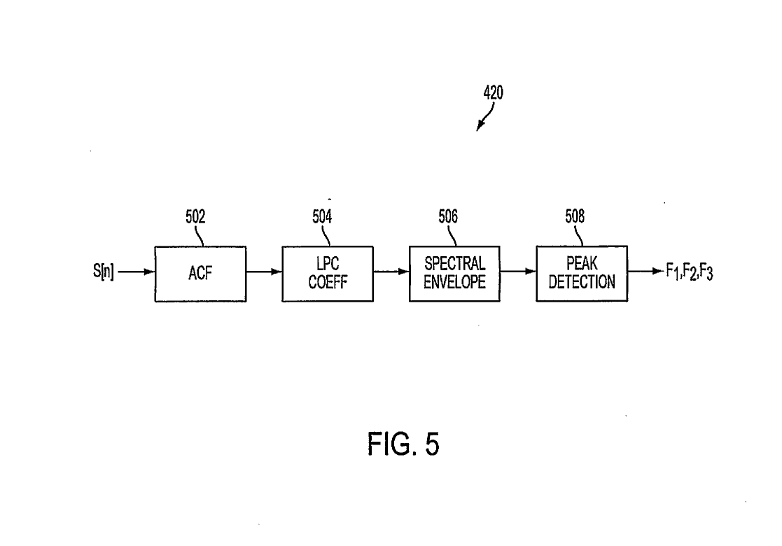

FIG. 2 is a block diagram illustrating the high level architecture of a noise reduction and speech enhancement system 200 according to one embodiment. In an embodiment, the noise reduction and speech enhancement system 200 may encompass software modules running on one or more processor of a computing device, such as computing device 102. At the front end, the audio is captured by the microphone 104, digitized, and input into the noise reduction system 200 in the form of audio data, such as pulse code modulation (PCM) samples (S[n]). The microphone signals may be monitored continuously (e.g., regardless of a headset's push-to-talk (PTT) status) in order to keep track of the background noise at all times. The audio may then be processed into frames, of N samples. This number N may depend on the sampling rate. Consistent with known speech processing algorithms, the frame size may be chosen to be between 1 and 100 milliseconds (e.g., 5-50 milliseconds, such as approximately 30 milliseconds). A frame overlap may be used, which may be 25-75 percent (e.g., 50 percent) of the frame size. When a complete frame is ready for processing, it may be windowed (such as using a hamming window) and then input to the VAD stage 202 of the system. The VAD stage 202 may perform operations as described below with reference to FIG. 3 to determine, among other attributes, whether each frame is a speech frame (i.e., includes audio data consistent with speech as described below) or non-speech frame. Each frame, along with the determination of whether the frame is a speech frame or a non-speech frame, may be passed to a noise reduction stage, such as an adaptive enhanced spectral subtraction stage 204 as shown in FIG. 2. The adaptive enhanced spectral subtraction stage 204 may perform operations as described below with reference to FIGS. 4, 5, and/or 6 to reduce the noise in the audio data of the frame and output noise reduced audio data Ŝ[n]. In one embodiment, the noise reduction stage may be an adaptive enhanced spectral subtraction stage. Optionally an iterative process may be used in which the output of the adaptive enhanced spectral subtraction stage 204 is fed back through the system (indicated by dashed line in FIG. 2) to improve performance. In an embodiment, after the complete noise reduced audio data Ŝ[n] (i.e., audio data corresponding to digital electrical signals representing reduced noise versions of the audio signal including the speech signal received by the microphone) is reconstructed it may be passed into the input of the automatic speech recognition system 206 as shown in FIG. 2.

FIG. 3 illustrates an embodiment method for voice activity detection. In an embodiment, the operations of the method illustrated in FIG. 3 may be performed by the processor of a computing device, such as the computing device 102 described above. As shown in FIG. 3, in a VAD stage, such as VAD stage 202 described above, features from both the time and frequency domain of the frame (for example using Fast Fourier Transforms (FFTs) in block 301) may be extracted and two adaptive thresholds may be applied to each of these features. In this embodiment, the first feature is the energy of the frame, a measure of the signal level (block 302). The second feature is spectral entropy, a measure of how organized the spectrum of the signal is (block 304). Both of these measures may be calculated using the frequency spectrum modified using a weighting function. The weighting function may be based on knowledge of auditory perception and analysis of noise signals commonly found in military and aviation environments. The first few (e.g., 5-10) frames of the microphone signal after the system is activated may be assumed to be background noise, or non-speech, and the energy (E) and entropy (H) of the first few frames (e.g., 5-10) may be provided directly to block 318 to set up thresholds without determining whether speech is included in the frame. The average values of energy (E) and entropy (H) for these preliminary frames may be used to set two thresholds for each feature. The first threshold (T₁) is the threshold that determines whether the signal has transitioned from non-speech into speech, and the second threshold (T₂) determines whether the signal has transitioned from speech into non-speech. Typically the non-speech to speech threshold (T₁) is higher (for both E and H values) than the speech to non-speech threshold (T₂).

After calculating the initial values (e.g., after the first few (e.g., 5-10) frames, the processor may determine whether speech is present or not present in each subsequent frame. For each frame, the system may determine whether the prior frame was classified as speech or non-speech (determination block 306) by determining whether the system is in speech mode or not in speech mode. In response to determining that the system is not in speech mode because the previous frame was classified as non-speech (i.e., determination block 306=“No”), the system may determine whether the current frame of audio data is a speech frame (i.e., classified as speech) or not a speech frame (i.e., classified as not speech) in determination block 308. In an embodiment, the frame of audio data may be classified as speech under the following conditions when the system is not in speech mode because the previous frame was classified as non-speech:

a) The energy (E) is greater than the first energy threshold (T_{E1}) (i.e., E>T_{E1}, see determination block 308); and

b) The entropy (H) is greater than the first entropy threshold (T_{H1}) (i.e., H>T_{H1}, see determination block 308).

In response to determining that the system is in speech mode because the previous frame was classified as speech (i.e., determination block 306=“Yes), the system may determine whether the current frame of audio data is a speech frame (i.e., classified as speech) or not a speech frame (i.e., classified as non-speech) in determination block 310. In an embodiment, in response to determining that the previous frame was classified as speech, the current frame may be classified as non-speech under the following conditions:

a) The energy (E) is less than the second energy threshold (T_{E2}) (i.e., E<T_{E2}, see determination block 310);

b) The entropy (H) is less than the second entropy threshold (T_{H2}) (i.e., H<T_{H2}, see determination block 310); and

c) These two criteria have been true for a minimum duration (e.g., at least the past 400 ms) of audio input (see determination block 312).

Based on the results of determination blocks 308, 310, and/or 312, a classification may be made as to whether the current frame is a speech frame (block 314) or a non-speech frame (block 316). For example, an indication regarding whether the current frame is a speech frame or non-speech frame may be stored in a memory of the computing device, such as by changing a flag setting in the memory.

For each frame, the background energy, entropy, and thresholds may be recursively adjusted (blocks 318, 320) using the previous background energy and entropy values and the current energy and entropy values if the current frame is classified as non-speech. In response to the current frame being classified as speech, estimates of the current background energy and entropy values may be applied to the update equations. The adaptive enhanced spectral subtraction stage of the system may depend on this speech or non-speech classification.

FIG. 4 illustrates an embodiment method for spectral subtraction noise reduction. In an embodiment, the operations of the method illustrated in FIG. 4 may be performed by the processor of a computing device, such as the computing device 102 described above. FIG. 4 illustrates one embodiment of a spectral subtraction noise reduction stage, such as a spectral subtraction noise reduction stage 204. The spectral subtraction noise reduction stage 204 may apply knowledge of whether the current frame is a speech frame or a non-speech frame (such as the determined classification of the current frame as described above with reference to FIG. 3, for example indicated by a flag in a memory of the computing device) and a modified, enhanced spectral subtraction algorithm to drastically reduce noise in the audio data with minimal speech corruption and sufficient intelligibility (e.g., for an ASR system). As stated above, the system may use the frequency spectrum of the windowed input frame, obtained using a fast Fourier transform algorithm (FFT) (block 402). The adaptive enhanced spectral subtraction stage may utilize the square of the magnitude spectrum (block 407), which may produce better results. The phase may be stored for use later when reconstructing the modified signal. The first few frames of the input signal may be assumed to be background noise, and the noise profile (block 404) may be initialized to the average of the squares of the magnitude spectra of these first few frames. Thus, in various embodiments, the ambient noise may be captured continuously and processed to identify the noise profile in the brief period (e.g., <100 milliseconds) prior to the user speaking.

After initialization, the output of the VAD may be checked for each frame (block 406). For example, the status of a flag setting in memory indicating whether the current frame was a speech frame or non-speech frame may be determined to check the output of the VAD. If the current frame is determined to be non-speech, the noise profile 404 may be recursively updated using a weighted average of the current squared magnitude spectrum and the previous squared magnitude spectrum. Thus, rapid changes in background noise, which may result from small changes in the location of the microphone, for example, may be captured and used to update the noise profile 404 just prior to the user speaking. Regardless of the VAD output, spectral subtraction may be applied on the current frame. The following steps describe the spectral subtraction procedure in one embodiment:

a) the spectrum may be split into L frequency bands based on the Bark scale (block 408), which approximates the logarithmic scale of human auditory perception;

b) the SNR for each band may be calculated using the current frame spectrum and the noise profile spectrum (block 410);

c) an over-subtraction factor for each band may be calculated based on the SNR of that frequency band (block 412);

d) for each band, spectral subtraction may be applied by multiplying the noise profile in that band by the appropriate over-subtraction factor and subtracting the resulting values from the current frame (block 414);

e) the square root of the resulting spectrum may be taken (block 415) and the phase stored earlier may be reapplied;

f) if the current frame is speech, a weighting function may be applied to the resulting spectrum that maximizes noise reduction while minimizing speech corruption (block 416); and

g) the spectrum may be converted back to the time domain and the overlap add method may be used to reconstruct the complete noise reduced audio data, Ŝ[n] (i.e., the complete noise reduced speech signal) (block 418).

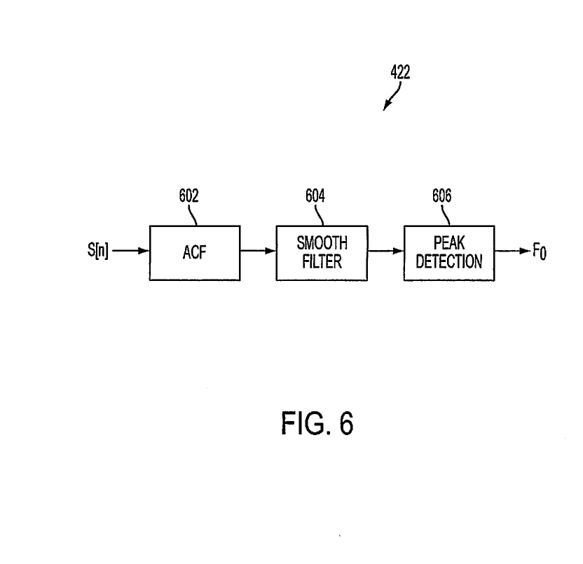

The weighting function, w(f), applied to the speech spectrum after spectral subtraction may be important in producing the best results from the ASR. This function may be based on formant (block 420) and harmonic (block 422) analysis of the spectrum and auditory perception properties. The formants may be computed by generating the linear prediction coefficients (LPCs) for the current frame and analyzing the poles of the resulting polynomial, as shown in FIG. 5. In an embodiment, the operations of the method illustrated in FIG. 5 may be performed by the processor of a computing device, such as the computing device 102. In an embodiment illustrated in FIG. 5, an autocorrelation function may be applied to the signal (block 502), the linear prediction coefficients (LPCs) may be generated (block 504), the spectral envelope may be computed by evaluating the all-pole LPC filter around the unit circle (block 506), and a peak detection may be used to find the local maxima in the resulting spectrum (block 508) which correspond to the formants, F₁, F₂, F₃. Harmonic analysis may be performed by computing the fundamental frequency of the current voiced frame as shown in FIG. 6. In an embodiment, the operations of the method illustrated in FIG. 6 may be performed by the processor of a computing device, such as computing device 102. The harmonics are integer multiples of this frequency. In an embodiment shown in FIG. 6, an autocorrelation function may be applied (block 602), a smooth filter (e.g., a 1^{st} order filter) may apply a smoothing function to reduce small variations in the ACF of the signal (block 604), and a peak detection may be used (block 606) to find the fundamental frequency, F₀.

The best results may be obtained when the weighting function applies a multiplication factor to each frequency bin in the spectrum proportional to perceptual filters, the location of the formants in the current frame, and/or the location of the fundamental frequency and harmonics in the current frame. Knowledge of the type of noise commonly seen in the environments in which the system is used may also contribute to the weighting function and increase the robustness of the system.

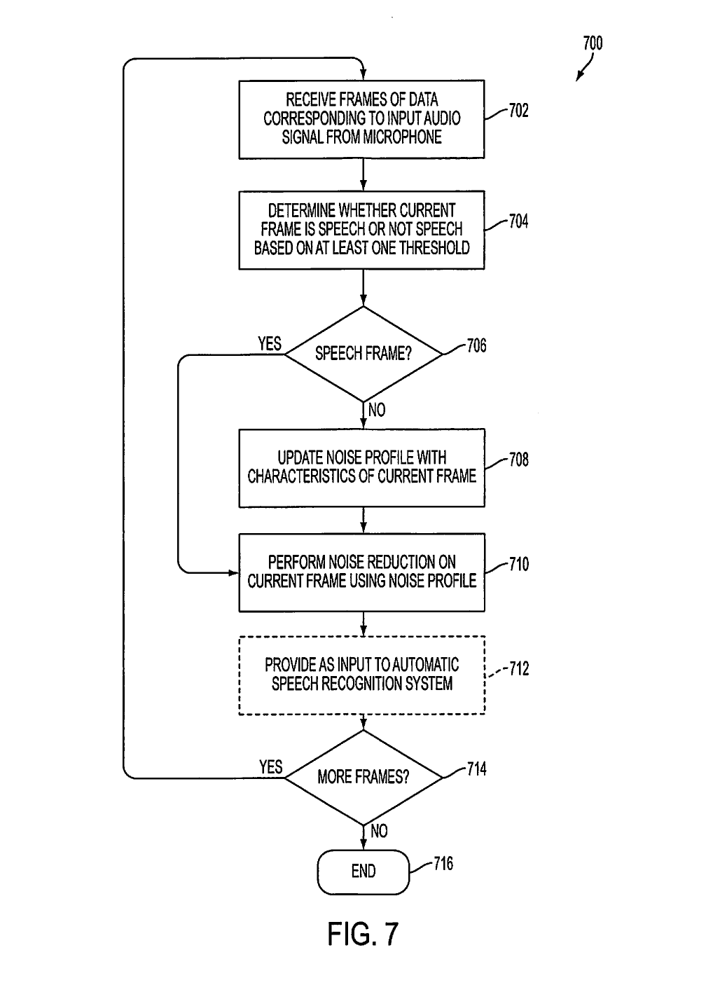

FIG. 7 illustrates an embodiment method 700 for reducing noise in an audio signal. In an embodiment, the operations of method 700 may be performed by a processor of a computing device, such as computing device 102 described above with reference to FIG. 1. In another embodiment, the operations of method 700 may be performed by the processors of one or more device, which may be connected by a network. In block 702, one or more frames of audio data corresponding to an input audio signal from a microphone may be received. As described above, the signal from a microphone may be digitized and the samples buffered into frames. Each frame may then be analyzed for example, sequentially, and in block 704 a determination may be made whether the current frame is a speech frame or a non-speech frame based on at least one threshold. For example, as discussed above, the frame may be converted to the frequency domain, and analyzed to determine characteristics of the frame, such as energy, E, and/or entropy, H. These characteristics may be compared to threshold values, which may be based, at least in part, on characteristics of one or more preceding frames. For example, a threshold value for energy (and/or entropy) for a current frame may be based on whether the preceding frame was a speech frame or a non-speech frame, as well as the characteristics (e.g., energy and/or entropy) of one or more preceding frames. The threshold value(s) may optionally be updated for successive frame(s) using the characteristics of the current frame.

In one example as described above, if the preceding frame was a non-speech frame, then the current frame may be determined to be a speech frame when the at least one characteristic of the frame (e.g., energy and/or entropy) is determined to exceed a corresponding first threshold value (T₁). Otherwise the frame may be determined to be non-speech. If the preceding frame was a speech frame, then the current frame may be determined to be a non-speech frame when the at least one characteristic of the frame (e.g., energy and/or entropy) is determined to be less than a corresponding second threshold value (T₂). Optionally, a plurality of consecutive frames (corresponding to a predetermined time period) must be less than the second threshold value (T₂) before the current frame may be determined to be a non-speech frame.

In response to determining that the current frame is a non-speech frame (i.e., determination block 706=“No”), the processor may perform the operations in block 708 and a noise profile may be updated with characteristics of the current frame. In one embodiment, the frame data may be in the frequency domain. Thus, spectral components of a non-speech frame may be assumed to be background noise and may be used to update a noise profile. In response to determining that the current frame is a speech frame (i.e., determination block 706=“Yes”), the processor may perform the operations in block 710 and a noise reduction may be performed on the current frame using the noise profile. In some embodiments, the noise reduction may be a spectral subtraction. The noise profile may be generated based on the spectral characteristics of one or more preceding frames that are determined to be non-speech frames. Thus, the noise profile may provide an accurate estimation of the spectral content of the background noise at the time the user begins speaking. The spectral subtraction may include subtracting energy from frequency bands corresponding to background noise while leaving the speech signal. The spectral subtraction may also include applying a weighting function to the resulting spectrum that increases noise reduction while minimizing speech corruption. The weighting function may be based on formant and/or harmonic analysis of the spectrum and/or auditory perception properties. The resultant frame data may be converted to the time domain and the original speech signal may be reconstructed. The reconstructed speech signal may optionally be provided as an input to an automatic speech recognition (ASR) system in optional block 712.

In response to determining that there are more additional frames to process (i.e., determination block 714=“Yes”), the processor may return to performing the operations in block 702, and the processor may repeat the operations of the method 700 for subsequent frames. In response to determining that there are no additional frames (i.e., determination block 714=“No”), then the processor may terminate the method 700 at block 716.

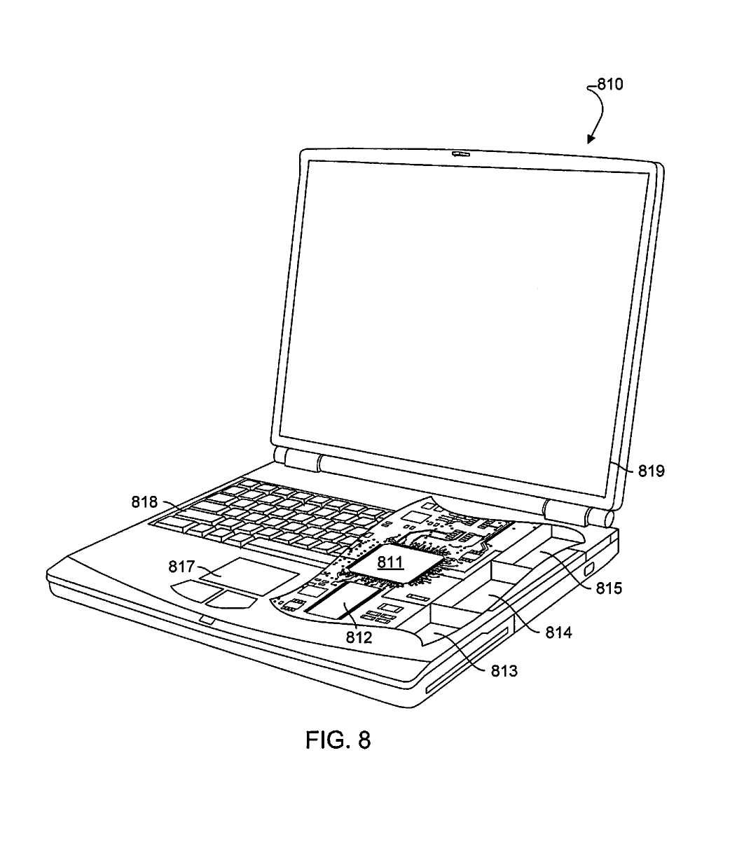

The various embodiments described above may be implemented within a variety of computing devices, such as a laptop computer 810 as illustrated in FIG. 8. Many laptop computers include a touch pad touch surface 817 that serves as the computer's pointing device, and thus may receive drag, scroll, and flick gestures similar to those implemented on mobile computing devices equipped with a touch screen display and described above. A laptop computer 810 will typically include a processor 811 coupled to volatile memory 812 and a large capacity nonvolatile memory, such as a disk drive 813 of Flash memory. The laptop computer 810 may also include a floppy disc drive 814 and a compact disc (CD) drive 815 coupled to the processor 811. The laptop computer 810 may also include a number of connector ports coupled to the processor 811 for establishing data connections (e.g., with a microphone) or receiving external memory devices, such as a USB or FireWire® connector sockets, or other network connection circuits (e.g., interfaces) for coupling the processor 811 to a network. In a notebook configuration, the computer housing may include the touchpad 817, the keyboard 818, and the display 819 all coupled to the processor 811. Other configurations of the computing device may include a computer mouse or trackball coupled to the processor (e.g., via a USB input) as are well known, which may also be use in conjunction with the various embodiments.

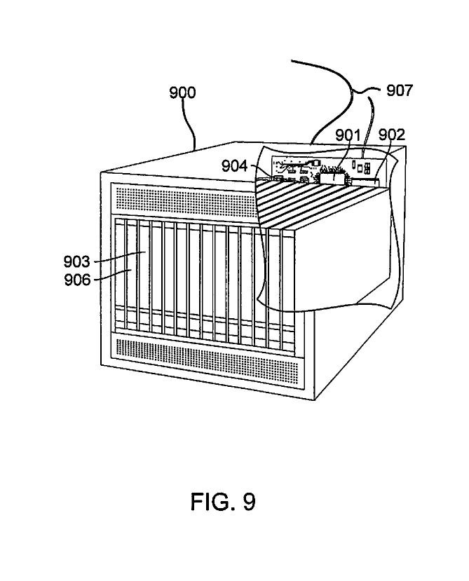

The various embodiments may also be implemented on any of a variety of commercially available server devices, such as the server 900 illustrated in FIG. 9. Such a server 900 typically includes a processor 901 coupled to volatile memory 902 and a large capacity nonvolatile memory, such as a disk drive 903. The server 900 may also include a floppy disc drive, compact disc (CD) or DVD disc drive 906 coupled to the processor 901. The server 900 may also include network access ports 904 (network interfaces) coupled to the processor 901 for establishing network interface connections with a network 907, such as a local area network coupled to other computers and servers, the Internet, the public switched telephone network, and/or a cellular data network, etc.

The processors 102, 811, and 901 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 102, 811, and 901. The processors 102, 811, and 901 may include internal memory sufficient to store the application software instructions. In many devices the internal memory may be a volatile or nonvolatile memory, such as flash memory, or a mixture of both. For the purposes of this description, a general reference to memory refers to memory accessible by the processors 102, 811, and 901 including internal memory or removable memory plugged into the device and memory within the processor 102, 811, and 901 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A noise reduction method, comprising:
determining, in a processor, whether a current frame of audio data corresponding to an audio signal from a microphone is a speech frame or a non-speech frame based on at least one threshold;
performing noise reduction in the processor on the current frame using a noise profile in response to determining that the current frame is a speech frame, wherein the noise profile is based on at least one characteristic of a previous frame of the audio data;
updating, in the processor, the noise profile with at least one characteristic of the current frame in response to determining the current frame is a non-speech frame; and
performing noise reduction in the processor on the current frame using the updated noise profile in response to determining that the current frame is a non-speech frame.

2. The method of claim 1, wherein the at least one threshold is based at least in part on the at least one characteristic of the previous frame of audio data.

3. The method of claim 2, wherein the at least one characteristic of the previous frame of audio data is a spectral energy or a spectral entropy.

4. The method of claim 1, wherein the noise profile comprises an estimate of the spectral content of background noise received at the microphone.

5. The method of claim 4, wherein performing noise reduction comprises performing spectral subtraction on the current frame using the noise profile.

6. The method of claim 4, wherein performing noise reduction further comprises applying a weighting function to the current frame.

7. The method of claim 6, wherein the weighting function is based on at least one of a formant analysis, a harmonic analysis, and auditory perception properties.

8. The method of claim 1, further comprising providing the frames to an automatic speech recognition system from the processor.

9. A device, comprising a processor configured with processor-executable instructions to perform operations comprising:
determining whether a current frame of audio data corresponding to an audio signal from a microphone is a speech frame or a non-speech frame based on at least one threshold;
performing noise reduction on the current frame using a noise profile in response to determining that the current frame is a speech frame, wherein the noise profile is based on at least one characteristic of a previous frame of the audio data;
updating the noise profile with at least one characteristic of the current frame in response to determining that the current frame is a non-speech frame; and
performing noise reduction on the current frame using the updated noise profile in response to determining that the current frame is a non-speech frame.

10. The device of claim 9, wherein the at least one threshold is based at least in part on the at least one characteristic of the previous frame of audio data.

11. The device of claim 10, wherein the at least one characteristic of the previous frame of audio data is a spectral energy or a spectral entropy.

12. The device of claim 9, wherein the noise profile comprises an estimate of the spectral content of background noise received at the single microphone.

13. The device of claim 12, wherein performing noise reduction comprises performing spectral subtraction on the current frame using the noise profile.

14. The device of claim 12, wherein performing noise reduction further comprises applying a weighting function to the current frame.

15. The device of claim 14, wherein the weighting function is based on at least one of a formant analysis, a harmonic analysis, and auditory perception properties.

16. The device of claim 9, further comprising providing the frames to an automatic speech recognition system.

17. A non-transitory processor readable storage medium having stored thereon processor-executable instructions configured to cause a processor to perform operations comprising:
determining whether a current frame of audio data corresponding to an audio signal from a microphone is a speech frame or a non-speech frame based on at least one threshold;
performing noise reduction on the current frame using a noise profile in response to determining that the current frame is a speech frame, wherein the noise profile is based on at least one characteristic of a previous frame of the audio data;
updating the noise profile with at least one characteristic of the current frame in response to determining that the current frame is a non-speech frame; and
performing noise reduction on the current frame using the updated noise profile in response to determining that the current frame is a non-speech frame.

18. The non-transitory processor readable storage medium of claim 17, wherein the stored processor-executable instructions are configured to cause a processor to perform operations such that:
the noise profile comprises an estimate of the spectral content of background noise received at the microphone; and
performing noise reduction further comprises applying a weighting function to the current frame, wherein the weighting function is based on at least one of a formant analysis, a harmonic analysis, and auditory perception properties.

19. The non-transitory processor readable storage medium of claim 17, wherein the stored processor-executable instructions are configured to cause a processor to perform operations further comprising providing the frames to an automatic speech recognition system.

20. The non-transitory processor readable storage medium of claim 17, wherein the stored processor-executable instructions are configured to cause a processor to perform operations such that the at least one threshold is based at least in part on the at least one characteristic of the previous frame of audio data and the at least one characteristic of the previous frame of audio data is a spectral energy or a spectral entropy.
